(19) United States
(12) Patent Application Publication
(10) Pub. No.: US 2003/0131094 A1
(43) Pub. Date: Jul. 10, 2003

(54) Apparatus and method of limiting application program usage

(75) Inventors: Faisal M. Awada, Round Rock, TX (US); Joe Nathan Brown, Austin, TX (US); Philip Bernard Burkes, Round Rock, TX (US); Arthur James Tysor, Buda, TX (US)

Correspondence Address: Mr. Volel Emile, P.O. Box 202170, Austin, TX, 78720-2170, US

(73) Assignee: International Business Machines Corporation

(21) Appl. No.: 10/045,279

(22) Filed: Jan. 10, 2002

(51) Int. Cl. G06F 15/16

(52) U.S. Cl. 709/224; 709/229

(57) ABSTRACT

A method, system and apparatus for limiting the use of an application program by a user are provided. A cross-reference table containing a list of all users authorized to use a computer system as well as a list of all application programs installed on a computer system is used. The cross-reference table includes an amount of time that each user is authorized to use an application program. When a user tries to execute the application program, a check of the table is made to determine whether the user is authorized to use the program. If the user is authorized to use the program, the program will be allowed to execute and a timer will be activated. The timer is used to ensure that the user does not spend more time using the application program than allowed. Another check may be made to ensure that the user is not using the application program more often than allowed.

### BACKGROUND OF THE INVENTION

1. Technical Field

The present invention is directed to a method and apparatus for managing the use of a computer system. More specifically, the present invention is directed to a method and apparatus for limiting the use of application programs in a computer system.

2. Description of Related Art

The past decade has seen an explosion in the number of new application programs being made available. These application programs range from the mundane (e.g., video games) to the utilitarian (e.g., encyclopedia). The availability of these application programs allows computer systems to be used for a variety of reasons other than just to perform work related tasks. However, the use of some of these application programs is so all consuming sometimes that a user may spend hours at a computer system without ever accomplishing the task for which the user originally wanted to use the computer system. Furthermore, the Internet, with its myriad of web sites on every topic imaginable, only exacerbates this problem.

What is needed, therefore, is a method and apparatus for limiting the amount of time an application program may be used.

### SUMMARY OF THE INVENTION

The present invention provides a method, system and apparatus for limiting the use of an application program by a user. A cross-reference table containing a list of all users authorized to use a computer system as well as a list of all application programs installed on a computer system is used. The cross-reference table includes an amount of time that each user is authorized to use an application program. When a user tries to execute the application program, a check of the table is made to determine whether the user is authorized to use the program. If the user is authorized to use the program, the program will be allowed to execute and a timer will be activated. The timer is used to ensure that the user does not spend more time using the application program than allowed. Another check may be made to ensure that the user is not using the application program more often than allowed.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 is a cross-reference table that may be used with the invention.

FIG. 5 depicts “start” menu of a computer system that does not have the invention installed.

FIG. 6 depicts “start” menu of a computer system with the invention installed.

FIG. 7 depicts a graphical user interface (GUI) for allowing the table in FIG. 4 to be filled in.

FIG. 8 is the cross-reference table of FIG. 4 with a new user added.

FIG. 9 is a flow chart of a process that may be used to fill-in the cross-reference table used by the invention.

FIG. 10 illustrates a flow chart of a process that may be used each time a user wants to use an application program.

### DETAILED DESCRIPTION OF THE PREFERRED EMBODIMENT

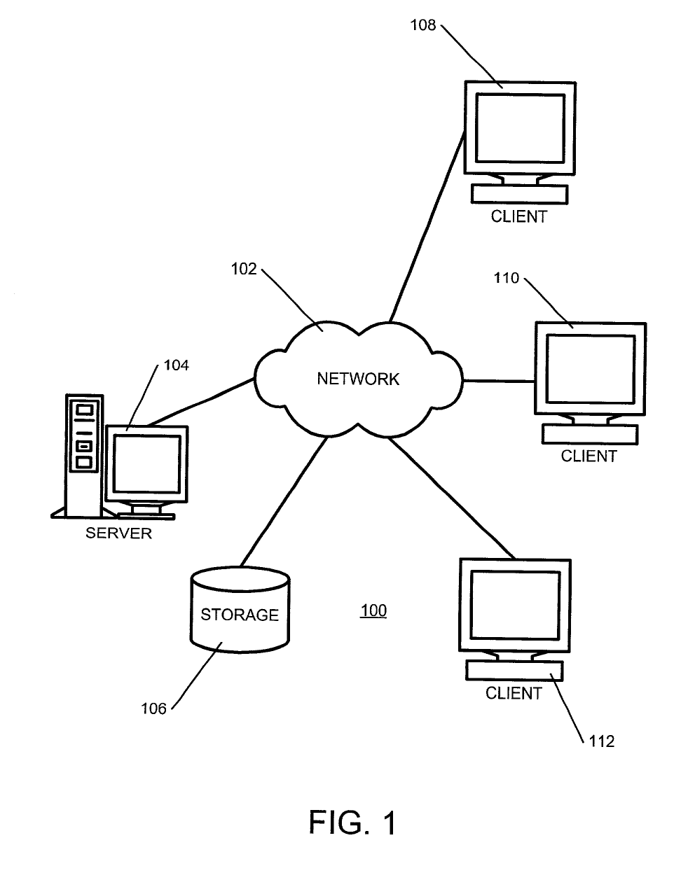

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

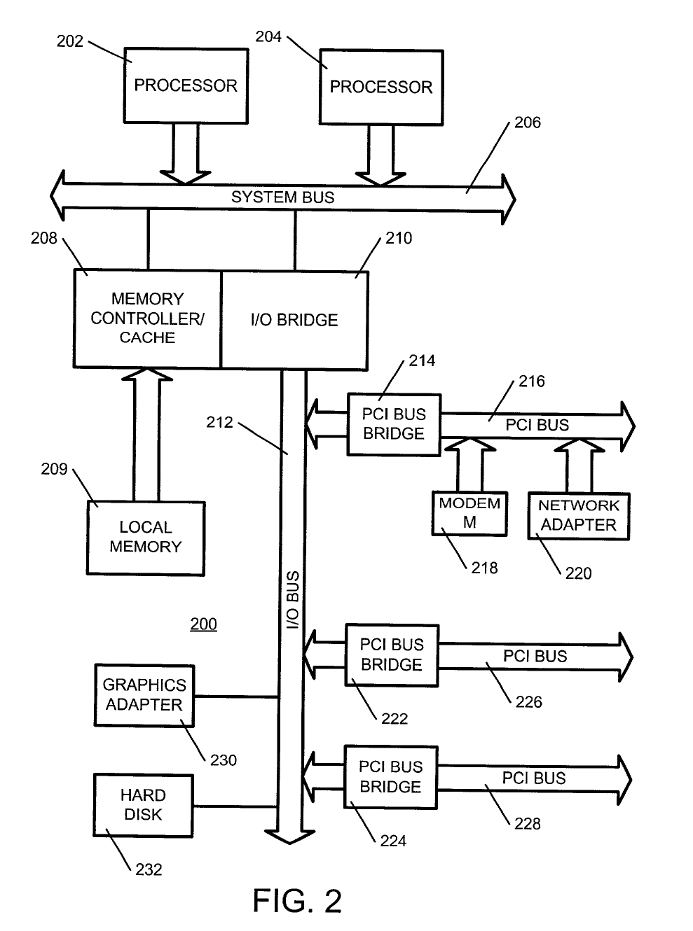

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, New York, running the Advanced Interactive Executive (AIX) operating system or LINUX operating system.

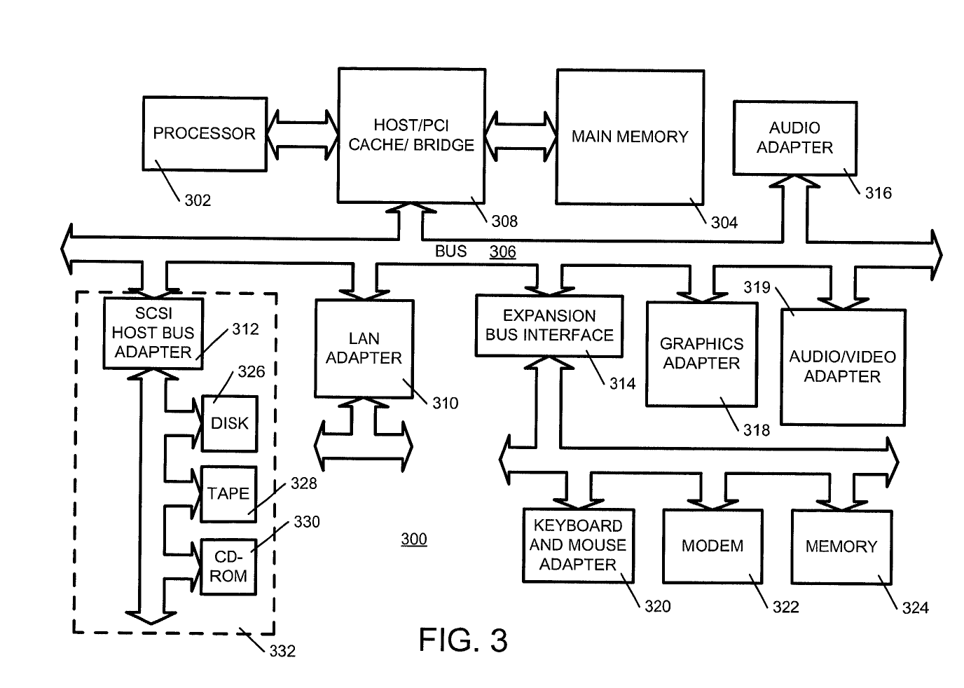

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus and method of limiting application program usage. The invention may be local to client systems 108, 110 and 112 of FIG. 1 or to the server 104 or to both the server 104 and clients 108, 110 and 112. Consequently, the present invention may reside on any data storage medium (i.e., floppy disk, compact disk, hard disk, ROM, RAM, etc.) used by a computer system.

The invention is based on an operating system's user access methodology. The system uses a table to cross-reference an amount of time a particular application program may remain active depending with a user. Thus, if a user wants to use an application program that has the time limitation, the user must first log onto the computer system. When the user launches the application program, a timer is activated. A comparison is then continuously made between the time on the timer and the time limit in the table to determine whether the two coincide. If so, then the application program will be de-activated or closed.

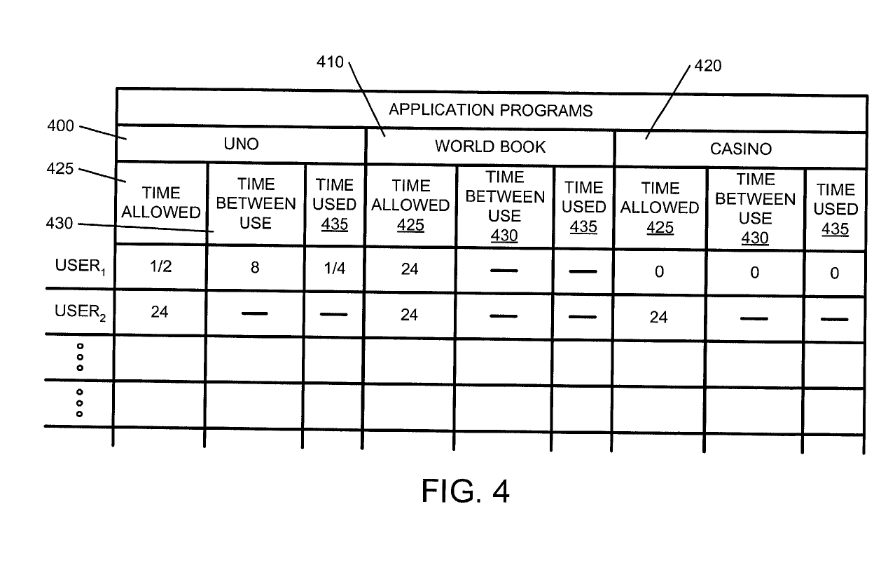

FIG. 4 is a cross-reference table that may be used with the invention. Depicted in FIG. 4 are three application programs, application program 400 (UNO), application program 410 (World Book) and application program 420 (Casino) and a plurality of users (i.e., user₁, user₂, . . . ). The users (i.e., user₁, user₂, . . . ) may have use-time restriction when using one, a few or all the application programs in the table. UNO 400 is a card game, World Book 410 is an educational learning tool and Casino 420 is a gambling game. Note that although three applications programs are shown, the invention is not restricted to only three. Any number of application programs may be used. Indeed, all the application programs (including web browsers) that have a use-restriction should be in the table; and obviously, all users who have a use-time restriction regarding any of the application programs should also be in the table.

Under each application program there are a time allowed column 425, a time between uses column 430 and a time used column 435. In the time allowed column 425 should be entered the amount of time a user is allowed to use an application program per day. In the time between uses column 430 should be entered the amount of time that must elapse before an application program may be successively used by a user. In the time used column 435 should be entered the amount of time a user has actually used an application program in a day. Everyday at midnight or within a 24-hour period, the entry in the time used column 435 may be cleared giving the users a blank slate for the next day or the next 24-hour period.

Note that instead of requiring that a certain amount of time elapse between uses of an application program, the table may be designed such that a user may only access an application program once a day. For example in the case of UNO, user₁ may play UNO for half hour every day. That is, as soon as the clock turns to twelve midnight, user₁ may play UNO again for another half hour, regardless as to whether user₁ started playing UNO at eleven-thirty in the evening (11:30PM) the previous day. Note that in this case the user would be allowed to play UNO for a whole hour uninterrupted. As should be obvious to one skilled in the art, any sort of variations may be implemented in the table.

In any event, the invention is particularly useful in a home environment where minors live. For example, user₁ may be a minor and user₂ an adult or a parent. The parent or user₂ may use any one of the application programs anytime the parent so desires, whereas the minor may only use certain non-school-related application programs for a certain amount of time each day. Specifically, user₁ may be allowed to play UNO up to half an hour at a time (see time allowed column 425 under UNO). After playing UNO for half an hour, user₁ must wait eight (8) hours before playing UNO again. However, if user₁ plays UNO for one quarter (¼) of an hour and stops, user₁ may at anytime resume playing UNO but only for another quarter (¼) of an hour. Furthermore, user₁ may use World Book 410 anytime and for any length of time that user₁ so desires. However, user₁ may not use Casino 420 at all.

The invention may be used to disallow unauthorized access to certain application programs on public computer systems. For example in a library environment, the table may be tailored such that application programs may be accessed based on user credentials (i.e., user age, parental permissions etc.).

Note that only application programs that have an associated use-time restriction are in the table. Generally, when an application is being installed, the installer may be prompted to indicate whether a use-time restriction should be associated with the application program. If the installer so indicates, the application program is entered into the table. Subsequently, the installer may access the table through the “start” menu of a computer system.

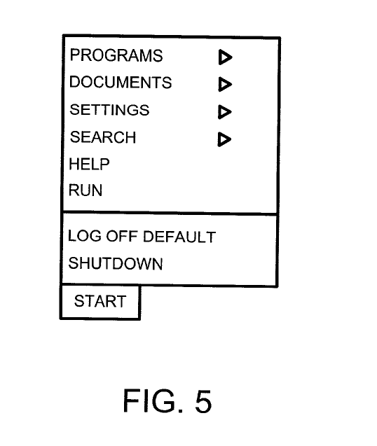

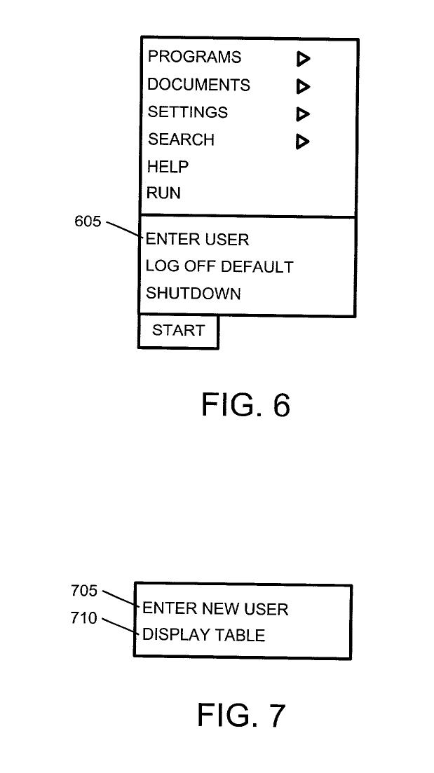

FIG. 5 depicts the “start” menu of a computer system that does not have the invention installed and FIG. 6 depicts the “start” menu of a computer system with the invention installed. When a user selects enter user 605, a window may pop open prompting the user to enter a password. After ensuring that the password is valid, FIG. 7 may be displayed.

In FIG. 7, either new user 705 or display table 710 may be selected. As the name implies, enter new user 705 is used to enter the name of a new user and display table 710 is used to make changes to the table. In either case however, FIG. 4 will be displayed. Once the table is displayed, the user may add new entries into the table as well as modify existing entries.

Obviously, if the use-restriction table is in a computer system that is used in a home environment, only an adult or an authorized person should be allowed to make entries into the table. In any other environment, a system administrator or an authorized person should make entries into the table.

In the implementation described above, only application programs that are associated with a use-time restriction are in the table. Thus, the application programs that are not in the table may be accessed by all without restriction. In addition, when these application programs are being used no one needs to log onto the computer system. However, the invention may be designed such that all application programs installed on the computer system are in the table. In this case, the application programs that may be used by all without restriction may have entries just like those found under the World Book 410 application program. And, of course, everyone has to log on to use the computer system.

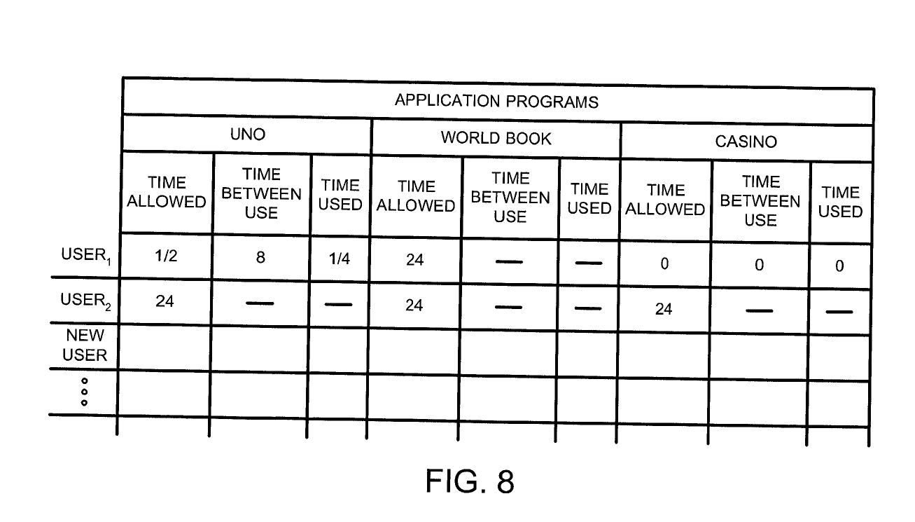

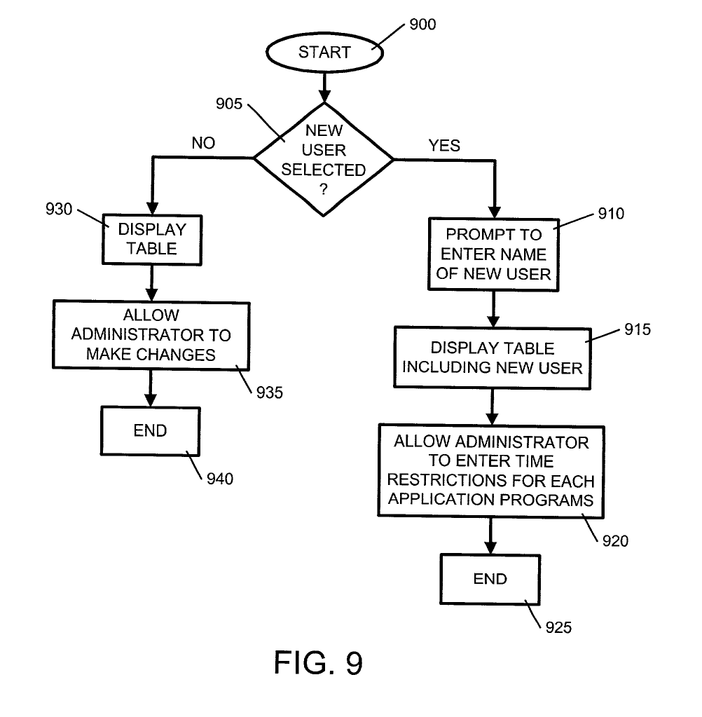

FIG. 9 is a flow chart of a process that may be used to fill-in the cross-reference table used in the invention. The process starts when either enter new user 705 or display table 710 is selected (step 900). If enter new user 705 is selected, the user will be prompted to enter the name of the new user. Then, the table will be displayed including a row for the new user as shown in FIG. 8. At this point, the administrator or authorized personnel may fill-in the cells of the table in accordance with the use authorization that the new user is to have (steps 905-925).

If display table 710 is selected, the table will be displayed. At this point, the administrator or authorized personnel may make any changes to the table including adding and deleting users as well as changing users' use authorization (step 905 and 930-940).

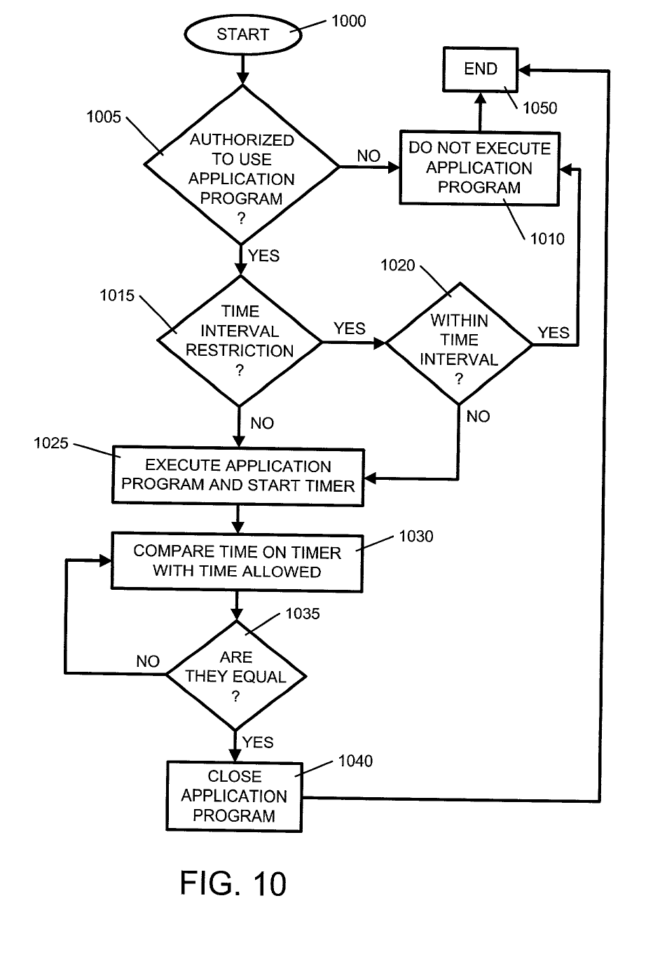

FIG. 10 illustrates a flow chart of a process that may be used each time a user wants to use an application program. The process starts when the user tries to execute the application program (step 1000). When that occurs, a check of the cross-reference table is made to determine whether the user is authorized to use the application program. Note that in the case where only application programs that have an associated restriction are entered into the table, if the application program is not in the table, the application program will start executing without any further checks. In the case where all applications installed on the computer system are in the table if the user does not have authorization to use the application program, the application program will not be allowed to execute and the process will end (steps 1005, 1010 and 1050).

If the user is allowed to use the application program, another check will be made to determine whether there is a time interval restriction (i.e., whether the user may only use the application program after a certain amount of time has elapsed since the user last used the program). If so, a further check is made to determine whether the amount of time has already elapsed. If not the user will not be allowed to use the application program (steps 1005, 1015, 1020 and 1010). If there is not a time interval restriction or if the required amount of time between executions of the program has elapsed, the application program will execute and a timer will start counting the amount of time that the application program is in execution (steps 1015, 1020 and 1025). This time is entered into time used column 435. A check will continuously be made to ascertain that the user does not use the application program longer than allowed (steps 1025, and 1030). When the time in time used column 435 matches the time in time allowed column 425 the application program will close and the process ends (steps 1035, 1040 and 1045).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of limiting an application program's usage by a user comprising the steps of:
executing the application program;
concurrently starting a timer; and
stopping execution of the application program if the timer registers a time equal or greater than a pre-determined time.

2. The method of claim 1 further comprising the step of ascertaining whether the user is permitted to use the application program before executing the application program.

3. The method of claim 2 wherein the step of ascertaining whether the user is allowed to use the application program further comprising the step of ensuring that there is not a time interval restriction.

4. The method of claim 3 further comprising the step of making sure that the time interval has elapsed before the user is allowed to use the application program if there is a time interval restriction.

5. The method of claim 4 wherein the pre-determined time is determined by an administrator.

6. A computer program product on a computer readable medium for limiting an application program's usage by a user comprising:
code means for executing the application program;
code means for concurrently starting a timer; and
code means for stopping execution of the application program if the timer registers a time equal or greater than a pre-determined time.

7. The computer program product of claim 6 further comprising code means for ascertaining whether the user is permitted to use the application program before executing the application program.

8. The computer program product of claim 7 wherein the code means for ascertaining whether the user is allowed to use the application program further comprising code means for ensuring that there is not a time interval restriction.

9. The computer program product of claim 8 further comprising code means for making sure that the time interval has elapsed before the user is allowed to use the application program if there is a time interval restriction.

10. The computer program product of claim 9 wherein the pre-determined time is determined by an administrator.

11. An apparatus for limiting an application program's usage by a user comprising:
means for executing the application program;
means for concurrently starting a timer; and
means for stopping execution of the application program if the timer registers a time equal or greater than a pre-determined time.

12. The apparatus of claim 11 further comprising means for ascertaining whether the user is permitted to use the application program before executing the application program.

13. The apparatus of claim 12 wherein the means for ascertaining whether the user is allowed to use the application program further comprising means for ensuring that there is not a time interval restriction.

14. The apparatus of claim 13 further comprising means for making sure that the time interval has elapsed before the user is allowed to use the application program if there is a time interval restriction.

15. The apparatus of claim 14 wherein the pre-determined time is determined by an administrator.

16. A computer system for limiting an application program's usage by a user comprising:
at least one memory device for storing code data; and
at least one processor for processing the code data to execute the application program, to concurrently start a timer, and to stop execution of the application program if the timer registers a time equal or greater than a pre-determined time.

17. The computer system of claim 16 wherein the processor further processes the code data to ascertain whether is the user is permitted to use the application program before executing the application program.

18. The computer system of claim 17 wherein the processor further processes the code data to ensure that there is not a time interval restriction.

19. The computer system of claim 16 wherein the processor further processes the code data to make sure that the time interval has elapsed before the user is allowed to use the application program if there is a time interval restriction.

20. The computer system of claim 19 wherein the pre-determined time i s determined by an administrator.
